(19) United States
(12) Patent Application Publication
(10) Pub. No.: US 2019/0112850 A1
(43) Pub. Date: Apr. 18, 2019

(54) HOLDER FOR A DOOR OR CASEMENT

(71) Applicant: Ms. Si Nenh D'Souza, Burnaby (CA)

(72) Inventors: Si Nenh D'Souza, Burnaby (CA); Jeffrey Doyle, Victoria (CA); Joshua Gregg Erickson, Victoria (CA)

(73) Assignee: Ms. Si Nenh D'Souza, Burnaby (CA)

(21) Appl. No.: 16/159,209

(22) Filed: Oct. 12, 2018

Related U.S. Application Data
(60) Provisional application No. 62/571,665, filed on Oct. 12, 2017.

(51) Int. Cl. E05C 17/04; E05C 17/00; E05C 17/08; E05C 17/16; E05C 17/30; E05C 17/48; E05C 17/54

(52) U.S. Cl. CPC E05C 17/047; E05C 17/025; E05C 17/08; E05C 17/54; E05C 17/30; E05C 17/48; E05C 17/163

(57) ABSTRACT

The present invention relates to a holder for at least one of a door and a casement. The at least one of the door and the casement is hingedly connected to a frame. The holder includes an elongate member assembly moveable from a retracted position to an extended position. The elongate member assembly has a pair of spaced-apart ends. The holder includes a pair of clamp assemblies pivotally connected to respective ones of the ends of the elongate member assembly. The clamp assemblies are configured to selectively couple with the frame and the at least one of the door and the casement.

### FIELD OF THE INVENTION

The present invention relates to a holder. In particular, the invention relates to a door or casement holder.

### DESCRIPTION OF THE RELATED ART

U.S. Pat. No. 2,398,602 to Sibley discloses a telescopic door holder in which all the operating parts are concealed and which is free from all projecting arms, handles, brackets and like parts, which constitute elements of construction.

U.S. Pat. No. 4,304,078 to Meriwether Jr. discloses an adjustable support apparatus for temporarily supporting a door frame or the like in a fixed relationship with one or more fixed supports suitably spaced therefrom, comprising: an elongated brace assembly including first and second telescoping members movable between contracted and extended positions and a setting device for fixing the first and second members in one of the contracted and extended positions; a first connector assembly at one end of the brace assembly adapted for removable attachment to a door frame; and a second connector assembly at the other end of the brace assembly adapted for removable attachment to one of the fixed supports.

### BRIEF SUMMARY OF INVENTION

There is accordingly provided, and it is an object to provide, an improved door/casement holder. The holder includes a length-adjustable elongate member assembly having a pair of spaced-apart ends. The holder includes a pair of clamp assemblies pivotally coupled to the ends of the elongate member assembly. Each clamp assembly includes an inner jaw positioned adjacent to a respective said end of the elongate member assembly.

There is also a holder for at least one of a door and a casement. The at least one of the door and the casement is hingedly connected to a frame. The holder includes an elongate member assembly moveable from a retracted position to an extended position. The elongate member assembly has a pair of spaced-apart ends. The holder includes a pair of clamp assemblies pivotally connected to respective ones of the ends of the elongate member assembly. The clamp assemblies are configured to selectively couple with the frame and the at least one of the door and the casement.

There is further provided a clamp assembly. The assembly includes a bar having a first end and a second end. The assembly includes a first jaw coupled to the first end of the bar. The assembly includes a second jaw positioned between the first end and the second end of the bar. The assembly includes a lever, actuation of which incrementally moves the second jaw towards the first jaw. The lever extends generally parallel to the bar.

### BRIEF DESCRIPTION OF DRAWINGS

The invention will be more readily understood from the following description of preferred embodiments thereof given, by way of example only, with reference to the accompanying drawings, in which:

FIG. 1 is a front, top perspective view a holder for a door or casement, the holder including an elongate member assembly and a pair of clamp assemblies pivotally coupled to ends thereof, and the holder being shown in an extended position and according to a first aspect;

FIG. 2 is a front elevation view of the holder of FIG. 1;

FIG. 3 is a top plan view of the holder of FIG. 1;

FIG. 4 is a front, top perspective view of the holder of FIG. 1 shown coupled to a door and a frame of the door in this example, with the elongate member assembly of the holder being shown in the extended position thereof;

FIG. 5 is a front, top perspective view of the holder of FIG. 1 shown coupled to the door and the frame of FIG. 4, with the elongate member assembly of the holder being shown in a retracted position;

FIG. 6 is a side perspective view of the holder of FIG. 1 shown coupled to a casement and a frame of the casement, with the elongate member assembly of the holder being shown in the extended position thereof;

FIG. 7 is a top perspective view of an elongate member assembly of a holder according to a second aspect, with the elongate member assembly being shown in fragment;

FIG. 8 is a top perspective view of an elongate member assembly of a holder according to a third aspect, with the elongate member assembly being shown in fragment;

FIG. 9 is a top perspective view of a clamp assembly and an elongate member assembly of a holder according to a fourth aspect, with the elongate member assembly being shown in fragment;

FIG. 10 is a top perspective view of a clamp assembly of a holder according to a fifth aspect, with the clamp assembly being shown in fragment;

FIG. 11 is a top perspective view of a clamp assembly of a holder according to a sixth aspect, with the rest of the holder not being shown;

FIG. 12 is a top perspective view of a holder for a door or casement according to a seventh aspect, the holder including a telescoping elongate member assembly with spaced-apart ends to which a frame clamp assembly and an object frame member are pivotally coupled thereto, the object being a door or window pane, with the clamp assemblies facing opposite directions, and with the elongate member assembly being shown in an extended position;

FIG. 13 is an enlarged, side end perspective of a quick-release mechanism of the elongate member assembly of the holder of FIG. 12;

FIG. 14 is a top perspective view of the holder of FIG. 12, with the elongate member assembly being shown in a retracted position;

FIG. 15 is a top perspective view of the frame clamp assembly of the holder of FIG. 12, with the elongate member assembly thereof being not shown;

FIG. 16 is a top perspective view of the object clamp assembly of the holder of FIG. 12, with the elongate member assembly thereof being not shown;

FIG. 17 is a top perspective view of the frame clamp assembly of FIG. 15, with a locking mechanism thereof being shown in actuated position for moving the outer jaw of the clamp assembly relative to the inner jaw of the clamp assembly;

FIG. 18 is a top perspective view of the frame clamp assembly of FIG. 17 with the outer jaw thereof shown abutting the inner jaw thereof;

FIG. 19 is a top perspective view of the frame clamp assembly of FIG. 17, with a trigger mechanism thereof shown in an actuated position;

FIG. 20 is a front, side perspective view of the holder of FIG. 12 shown coupled to a door and a frame of the door, with the elongate member assembly of the holder being shown in the retracted position thereof, and with the door and frame being shown in fragment;

FIG. 21 is a front perspective view of the holder of FIG. 20 shown coupled to the frame of the door of FIG. 21, with the holder being shown in fragment;

FIG. 22 is a top, side perspective view of a holder for a door or casement according to an eighth aspect;

FIG. 23 is a side perspective view of the holder of FIG. 22;

FIG. 24 is a top, side perspective view of a holder for a door or casement according to a ninth aspect, with the holder including a pair of storage brackets;

FIG. 25 is an enlarged perspective view of one of the storage brackets of FIG. 24, together with the elongate mounting assembly of the holder of FIG. 24 and a bar of one of the clamping assemblies of the holder of FIG. 24, the elongate mounting assembly and the bar being shown in fragment and the storage bracket being shown coupled to the elongate mounting assembly and in the process of being coupled to the bar; and

FIG. 26 is an enlarged perspective view of the storage bracket, elongate mounting assembly and bar of FIG. 25, with the elongate mounting assembly and the bar being shown in fragment and the storage bracket being shown coupled to both the elongate mounting assembly and the bar.

### DESCRIPTION OF THE PREFERRED EMBODIMENTS

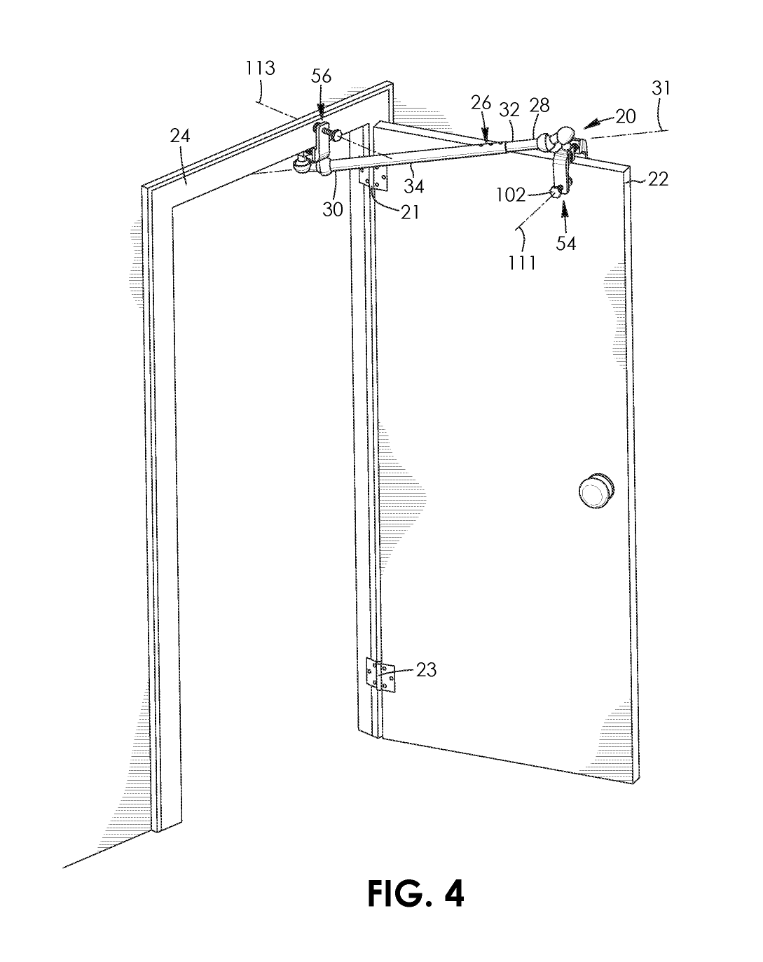

Referring to the drawings and first to FIG. 4, there is provided a holder 20 for fixing angular positioning of an object, in this example a door 22 relative to a frame 24 thereof. The door and frame are conventional, with the door being hingedly connected to the frame via hinges 21 and 23.

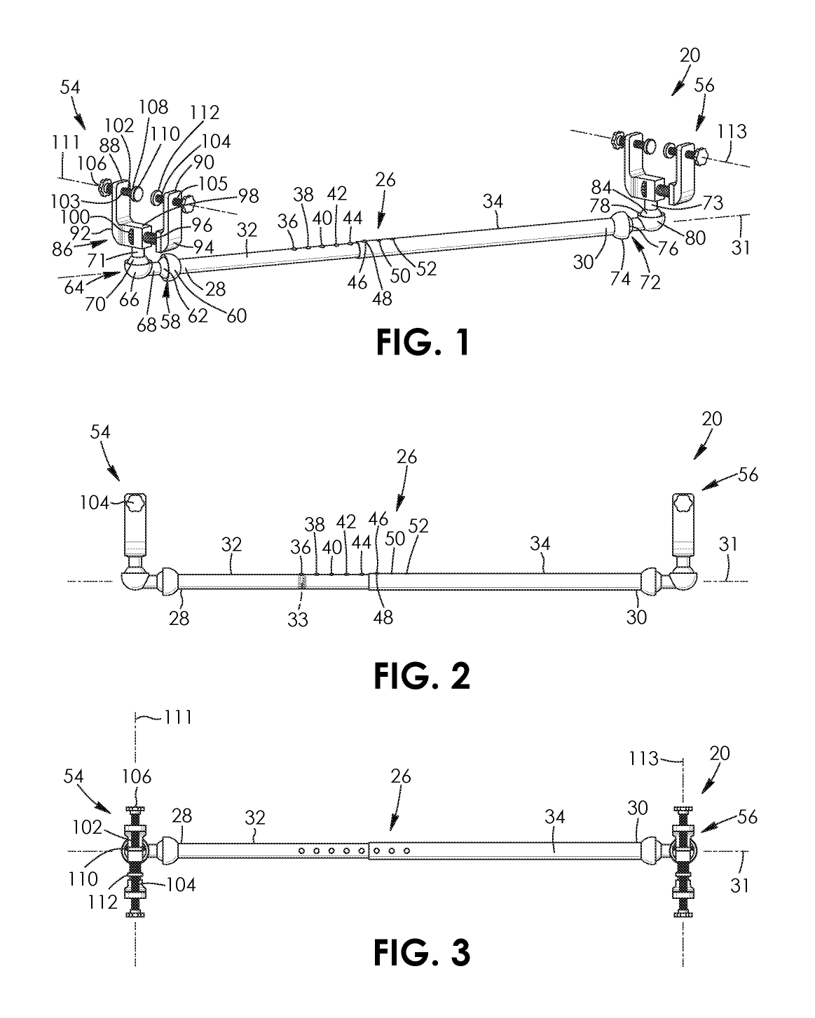

As seen in FIG. 1, the holder 20 includes a length-adjustable elongate member assembly 26 having a pair of spaced-apart ends 28 and 30. The elongate member assembly includes a longitudinal axis 31 which extends between ends 28 and 30 thereof. The elongate member assembly includes an inner, first tube 32 which extends from end 28 towards end 30 thereof. The first tube includes in this example a plurality of longitudinally spaced-apart rounded projections 36, 38, 40, 42, 44 and 46. The rounded projections are spring-biased radially outwards in this example, as shown by spring 33 seen in ghost lines in FIG. 2 biasing projection 36 outwards.

The elongate member assembly 26 includes an outer, second tube 34 which is telescopically coupled to the first tube 32. The second tube extends from end 30 towards end 28 of the elongate member assembly. The second tube 34 has in this example a plurality of longitudinally spaced-apart apertures 48, 50 and 52 shaped to receive respective ones of the rounded projections 36, 38, 40, 42, 44 and 46.

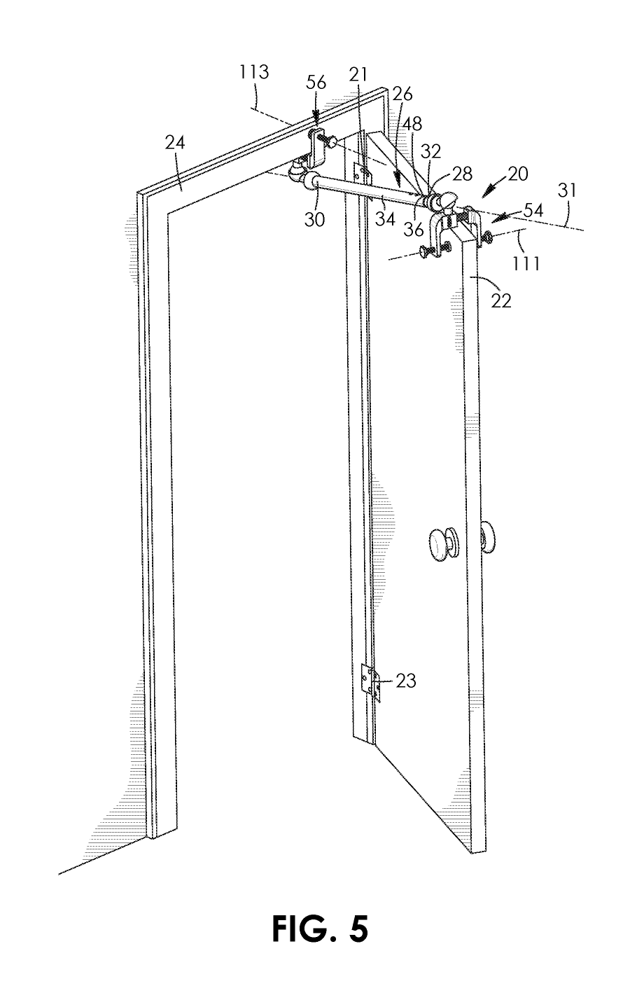

Actuation of or pushing in the rounded projections 36, 38, 40, 42, 44 and 46 enables the first tube 32 to be received within the second tube 34, with the elongate member assembly 26 thus being moveable from a retracted position seen in FIG. 5, to an extended position seen in FIG. 4. Referring to FIG. 5, rounded projection 36 closest to end 28 of the elongate member assembly 26 extends through aperture 48 furthest from end 30 of the elongate member assembly when the elongate member assembly is in the retracted position in this example, and is therefore in a locked position. Referring to FIG. 1, rounded projection 46 closest to end 30 of the elongate member assembly 26 extends through aperture 48 furthest from end 30 of the elongate member assembly when the elongate member assembly is in its extended position in this example, and is also therefore in a locked position. The rounded projections 36, 38, 40, 42, 44 and 46, and apertures 48, 50 and 52 of the tubes may be referred to as a locking mechanism of the holder 20 which inhibits longitudinal and rotational movement of the first tube relative to the second tube.

As seen in FIG. 1, the holder includes a pair of clamp assemblies 54 and 56 pivotally connected to respective ones of the ends 28 and 30 of the elongate member assembly 26.

Each of the clamp assemblies pivotally couples to the elongate member assembly via in this example at least one ball joint, and in this case via a pair of ball joints. In this embodiment, there are four sets 58, 64, 72 and 78 of balls and sockets. In particular, the holder 20 includes a first one of the first set 58 of a ball and a socket, in this example a socket 60 coupled to end 28 of the elongate member assembly. The holder includes a second one of the first set of the ball and the socket, in this example ball 62 pivotally connecting to and partially received within socket 60. The holder 20 includes a first one of the second set 64 of a ball and a socket, in this example a socket 66 coupled to ball 62 of first set 58 via elongate rod 68. The holder includes a second one of the second set 64 of the ball and the socket, in this example ball 70 pivotally connecting to and receiving socket 66. Ball 70 couples to clamp assembly 54 via an outer elongate member, in this example shaft 71.

The holder 20 includes a first one of the third set 72 of a ball and a socket, in this example socket 74 coupled to end 30 of the elongate member assembly 26. The holder includes a second one of the third set 72 of the ball and the socket, in this example ball 76 pivotally connecting to and received within socket 74. The holder 20 includes a first one of a fourth set 78 of the ball and a socket, in this example socket 80 coupled to ball 76 via elongate rod 82. The holder includes a second one of the fourth set 78 of the ball and the socket, in this example ball 84 pivotally connecting to and receiving socket 80. Ball 84 couples to clamp assembly 56 via an outer elongate member, in this example shaft 73. The elongate member assembly 26 thus pivotally connects to and extends between shafts 71 and 73.

As seen in FIG. 1, each clamp assembly 54 is U-shaped and includes a length-adjustable base assembly 86 and a pair of side portions 88 and 90 coupled to and extending outwards from spaced-apart ends 92 and 94 of the base assembly. The base assembly includes a male threaded member 96 coupled to side portion 88 and a female threaded member 98 shaped to threadably engage with and receive the male threaded member. The female threaded member is rotatably coupled to side portion 90 of the clamp assembly in this example.

Each clamp assembly 54 includes an actuation member or dial 100 rotatably mounted to side portion 88. Rotation of the dial causes the threaded members 96 and 98 to move towards retracted or extended positions. The dial 100 is used to lock the extendable portion of the clamp assembly which is located on the horizontal base. This function will allow for a much deeper door frame/window frame to be fitted between the jaw clamp.

As seen in FIG. 1, each clamp assembly 54 includes a pair of thumb screws 102 and 104. The thumb screws threadably engage with and extend through apertures 103 and 105 of the side portions 88 and 90 of the clamp assemblies. Each thumb screw 102 has an outer hand-grippable end 106 and an inner end 108. Each clamp assembly 54 includes a pair of jaws 110 and 112 positioned between the side portions 88 and 90 thereof and coupled to the inner ends 108 of the thumb screws. Jaw 110 thus couples to side portion 88 of the clamp assembly and jaw 112 thus couples to side portion 90 of the clamp assembly. Each clamp assembly includes a longitudinal axis extending through and aligning with the jaws thereof, as shown in FIG. 1 by longitudinal axis 111 for clamp assembly 54 and longitudinal axis 113 for clamp assembly 56. Referring to FIG. 4, each of the clamp assemblies 54 and 56 is clamped in place to couple with the door 22 and frame 24 via actuation of the thumb screws.

In this manner and referring to FIG. 4, the clamp assemblies 54 and 56 of the holder 20 may selectively clamp to the door 22 and door frame 24, respectively, and the elongate member assembly 26 may be adjusted length-wise until a desired opening of the door is obtained. The elongate member assembly is next locked into position via projections 36, 38, 40, 42, 44 and 46 being inserted within respective apertures 48, 50 and 52. The holder 20 thus functions to hold the door in place in said desired positioning.

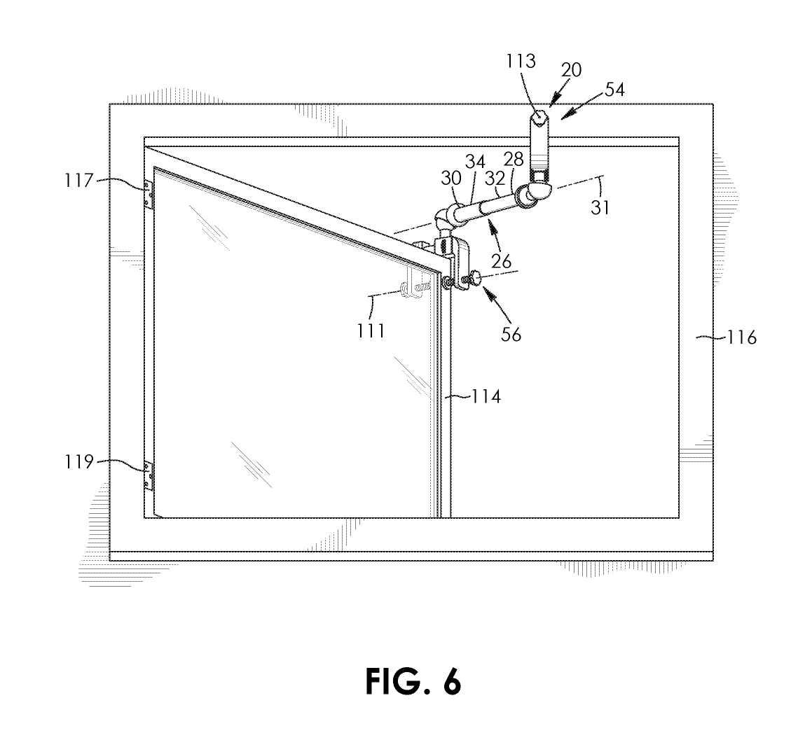

FIG. 6 shows a window casement 114 hingedly coupled to a window frame 116 via hinges 117 and 119. In a similar manner as described above, the clamp assemblies 54 and 56 of the holder 20 may selectively clamp to the frame and casement, with the elongate member assembly 26 being adjusted length-wise until a desired window opening is achieved. In both of the above cases, the holder 20 may thus function to inhibit undesired changes in the position of the door/window and may further function to inhibit unintentional slamming of the door/window shut.

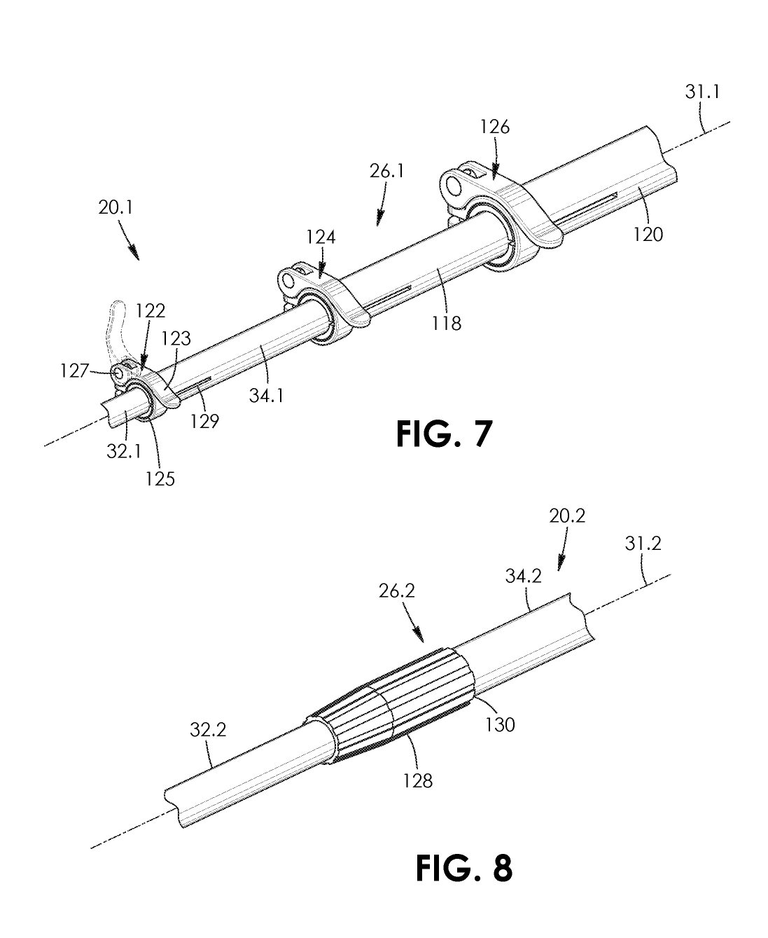

FIG. 7 shows an elongate member assembly 26.1 of a holder 20.1 according to a second embodiment, with the elongate member assembly being shown in fragment. Like parts have like numbers and function as the embodiment shown in FIGS. 1 to 6 with the addition of decimal extension “.1”. Holder 20.1 is substantially the same as holder 20 shown in FIGS. 1 to 6 with the exception that the elongate member assembly 26.1 employs a variation in its length-adjusting mechanism.

In particular, the elongate member assembly 26.1 comprises a plurality of telescoping tube segments 32.1, 34.1, 118, and 120 each of which is releasable, retractable or extendable and lockable in place via the actuation of a plurality of quick-release mechanisms 122, 124 and 126. Each quick release mechanism includes a lever 123 pivotally coupled to an end 125 of its respective tube segment 34.1 via pivot point 127. Each tube segment 32.1 has a longitudinally-extending opening, in this example an elongate slit 129 which extends longitudinally from end 125 thereof. The lever 123 has an open position, shown in dotted lines, in which adjacent tube segments 32.1 and 34.1 are moveable relative to each other and in which the lever is angled and in this example perpendicular to its tube segment 34.1 in this example. Each lever is moveable from its open position to a closed or locked position, shown in solid lines, in which the lever extends along and adjacent to its tube segment.

Each quick release mechanism 122 is configured to narrow the slit 129 of its respective tube segment 34.1 so as to frictionally engage adjacent tube segment 32.1 when the lever 123 has been actuated to its locked position. Put another way, each lever is configured such that selective actuation of the lever causes the effective cross-sectional area of the adjacent end 125 of the tube segment to which the lever is mounted to reduce, thereby functioning to clamp said end about adjacent tube segment 32.1. In this manner the length of the elongate member assembly 26.2 is selectively adjustable.

FIG. 8 shows an elongate member assembly 26.2 of a holder 20.2 according to a third embodiment. Like parts have like numbers and function as the embodiment shown in FIGS. 1 to 6 with the addition of decimal extension “.2”. Holder 20.2 is substantially the same as holder 20 shown in FIGS. 1 to 6 with the exception that the elongate member assembly 26.2 employs a further variation in its length-adjusting mechanism.

In particular, the elongate member assembly 26.2 comprises a rotatable member 128 positioned adjacent to the distal end 130 of tube 34.2. Selective actuation of the rotatable member 128 causes the effective cross-sectional area of the distal end 130 to reduce, thereby functioning to clamp said end about tube 32.2. In this manner, positioning of the tubes 32.2 and 34.2 relatively to each other may be selectively adjustable and thereafter fixed in place.

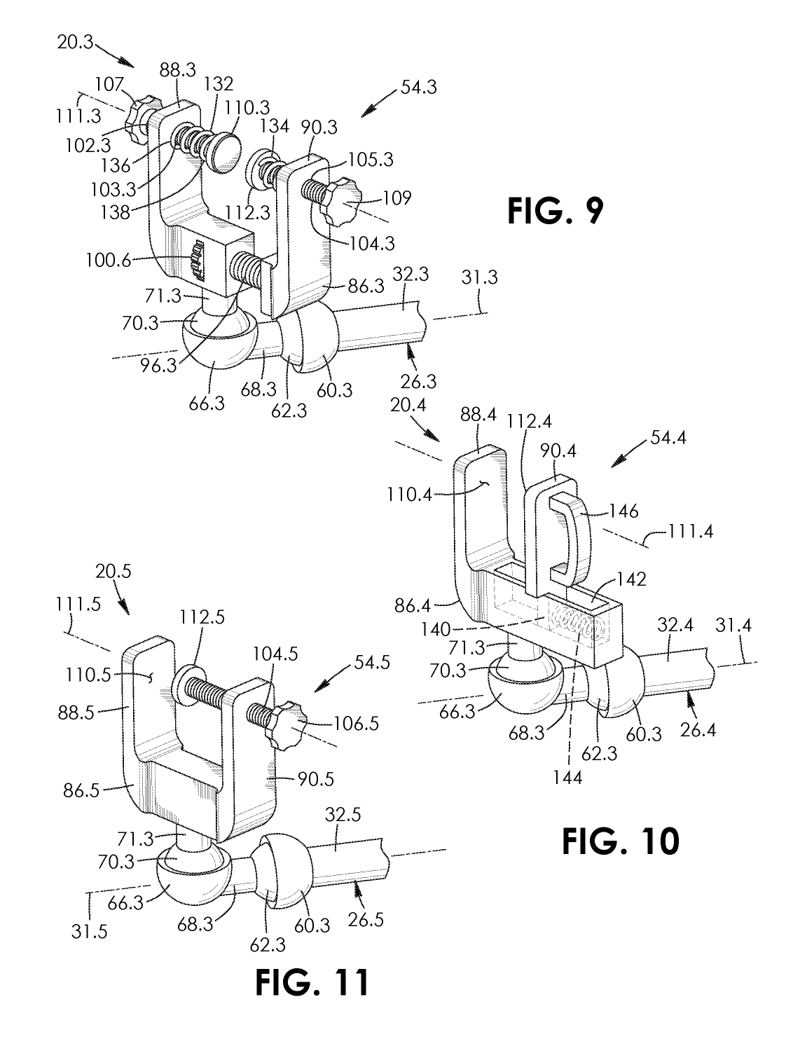

FIG. 9 shows a clamp assembly 54.3 of a holder 20.3 according to a fourth embodiment. Like parts have like numbers and function as the embodiment shown in FIGS. 1 to 6 with the addition of decimal extension “.3”. Holder 20.3 is substantially the same as holder 20 shown in FIGS. 1 to 6 with the following exceptions.

The clamp assembly 54.3 includes a pair of rods 102.3 and 104.3 slidably extendable through apertures 103.3 and 105.3 of respective ones of the side portions 88.3 and 90.3 of the clamp member. Each clamp assembly includes a pair of resilient members, in this example coil springs 132 and 134. Each spring extends about one of the rods 102.3 and 104.3. Each spring 132 has an outer end 136 abutting one of the side portions 88.3 of the clamp assembly 54.3, and an inner end 138 abutting a respective one of jaws 110.3 of the clamp member. The jaws 110.3 and 112.3 are thus spring-biased towards each other.

The clamp assembly 54.3 is thus spring-biased towards its closed position. The grippable ends 107 and 109 can be selectively pulled away from the side portions 88.3 and 90.3 of the clamp member, the clamp assembly is next positioned around a door/casement or frame, and the grippable ends are next released, with springs 132 and 134 thereafter moving the jaws 110.3 and 112.3 to abut against the door/casement or frame.

FIG. 10 shows a clamp assembly 54.4 of a holder 20.4 according to a fifth embodiment. Like parts have like numbers and function as the embodiment shown in FIGS. 1 to 6 with the addition of decimal extension “.4”. Holder 20.4 is substantially the same as holder 20 shown in FIGS. 1 to 6 with the following exceptions.

As seen in FIG. 10, side portion 90.4 of the clamp assembly 54.4 includes a lower protrusion 140 which extends within and along a slit 142 of side portion 88.4 of the clamp member. The holder 20.4 includes a resilient member, in this example a coil spring 144 disposed within side portion 88.4 of the clamp member. The coil spring is positioned to abut lower protrusion 140 of side portion 90.4 of the clamp assembly 54.4. Side portion 90.4 of the clamp assembly 54.4 is thus spring-biased towards the side portion 88.4 of the clamp assembly in this embodiment. The side portions of the clamp assembly are thus spring biased towards a closed position.

Side portion 90.4 includes a handle 146 for selectively spacing/pulling-apart side portion 90.4 of the clamp assembly 54.4 from side portion 88.4 of the clamp assembly towards an open position of the clamp assembly when positioning the clamp assemblies to receive the door/casement and frame. Thereafter, the handle is released and the holder 20.4 clamps onto the door/casement and frame thereby.

FIG. 11 shows a clamp assembly 54.5 of a holder 20.5 according to a sixth embodiment. Like parts have like numbers and function as the embodiment shown in FIGS. 1 to 6 with the addition of decimal extension “.5”. Holder 20.5 is substantially the same as holder 20 shown in FIGS. 1 to 6 with the following exceptions.

As seen in FIG. 11, the clamp assembly 54.5 is U-shaped, with side portions 88.5 and 90.5 and base assembly 86.5 thereof being integrally connected and forming a unitary whole. The clamp assembly includes a single threaded thumb screw 104.5 threadably coupled to side portion 90.5 of the clamp member. Actuation of the thumb screw moves the clamp assembly 54.5 from an unclamped position to a clamped position.

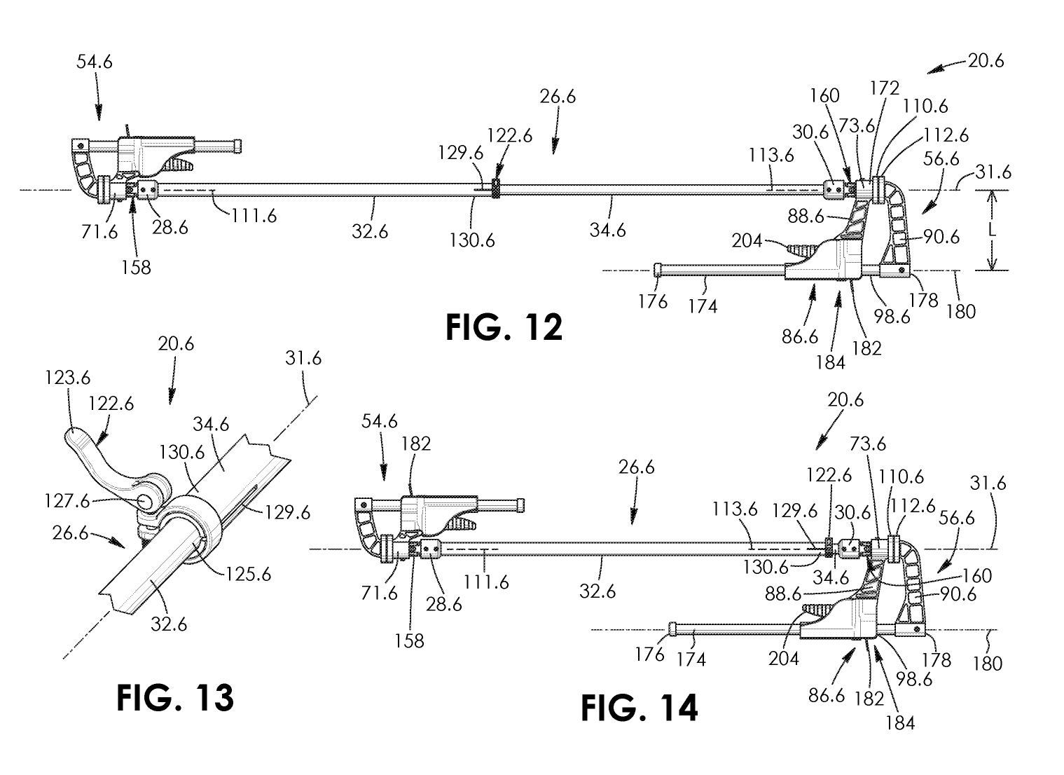

FIGS. 12 to 21 show a door/casement holder 20.6 according to a seventh embodiment. Like parts have like numbers and function as the embodiment shown in FIGS. 1 to 6 with the addition of decimal extension “.6”. Holder 20.6 is substantially the same as holder 20 shown in FIGS. 1 to 6 with the following exceptions.

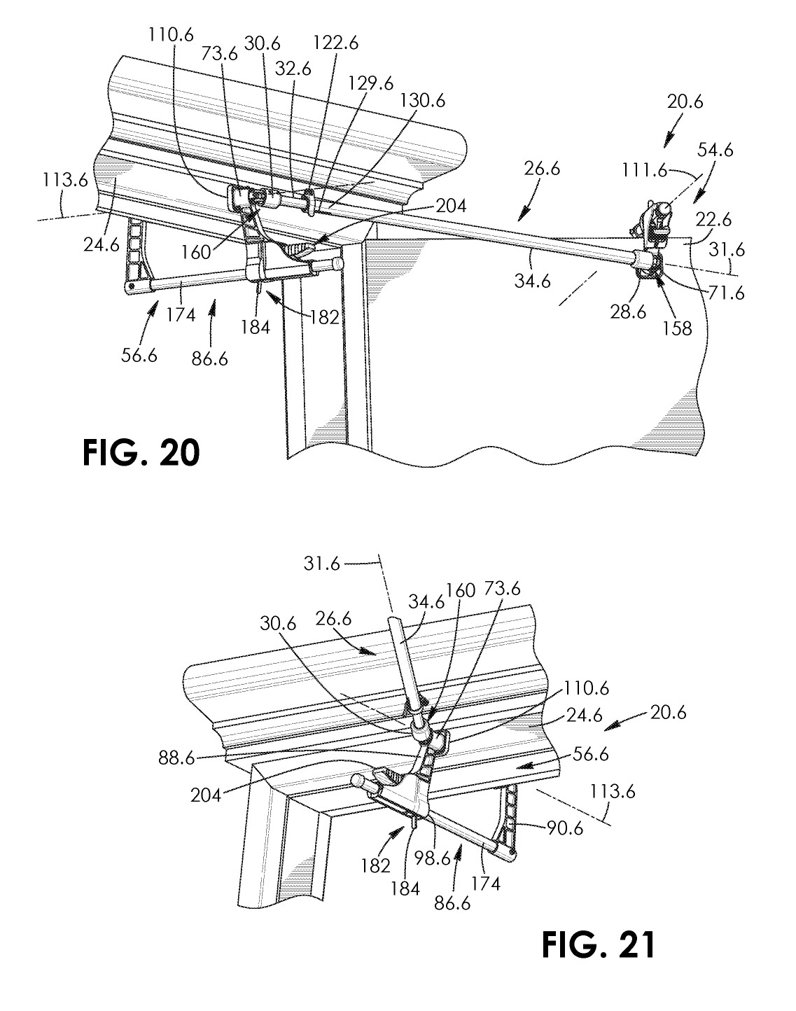

As seen in FIG. 12, each clamp assembly 56.6 includes an outer side portion 90.6 to which the outer jaw 112.6 of the clamp assembly couples and an inner side portion 88.6 to which the inner jaw 110.6 of the clamp assembly couples. The lengths L of the side portions of clamp assembly 56.6, extending the base assembly 86.6 to the jaws, are longer than those of clamp assembly 54.6 to accommodate frame 24.6 seen in FIG. 20. Otherwise, the clamp assemblies are substantially the same in parts and functions and thus only clamp assembly 56.6 will be described in detail.

The clamp assemblies 54.6 and 56.6 are pivotally coupled to the ends 28.6 and 30.6 of the elongate member assembly 26.6 in this example via universal joints 158 and 160. As seen in FIG. 16, each universal joint comprises a pair of yokes 162 and 164 that couple together via cross member 166. The cross member includes a body 167 that is a rectangular prism in shape. The cross member 166 includes a first pair of spaced-apart pins, of which pin 168 is seen in FIG. 16, coupled to and extending outwards from opposed sides 169 of the body. Yoke 162 receives and is pivotable about pins 168. The cross member includes a second pair of spaced-apart pins, of which pin 170 is seen in FIG. 16, coupled to and extending from further opposed sides 171 of the body 167. Yoke 164 receives and is pivotable about pins 170.

As seen in FIG. 12, the inner jaws 110.6 of the clamp assembly 54.6 and 56.6 are positioned adjacent to respective ends 28.6 and 30.6 of the elongate member assembly 26.6 in this embodiment. The inner jaw of each said clamp assembly is positioned adjacent to a respective universal joint 160 of the elongate member assembly in this embodiment. The inner jaws 110.6 of the clamp assemblies 56.6 couple to distal ends 172 of the outer elongate members 73.6. As seen in FIG. 12, the clamp assemblies 54.6 and 56.6 have non-rotated positions in which the longitudinal axes 111.6 and 113.6 thereof align coaxially with the longitudinal axis 31.6 of the elongate member assembly 26.6.

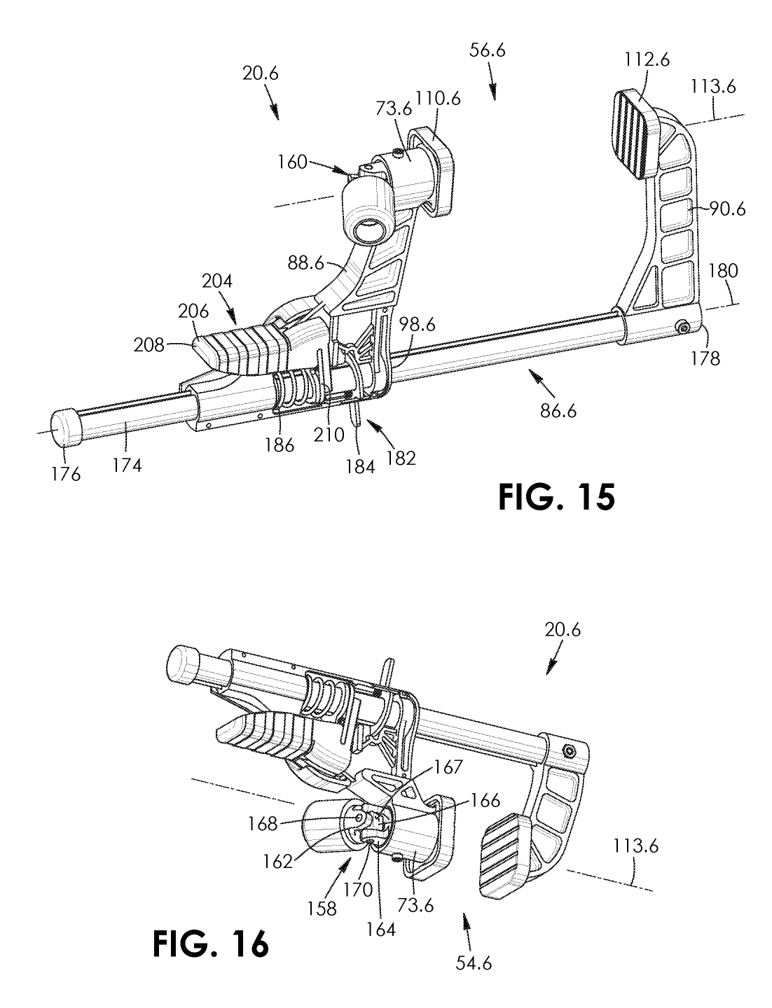

As seen in FIG. 15, each clamp assembly 56.6 includes a bar 174 having a first end 176, a second end 178 and a longitudinal axis 180 extending between the ends thereof. As seen in FIG. 12, the bars are spaced-apart from the elongate member assembly 26.6. Referring back to FIG. 15, the longitudinal axis 180 of each clamp assembly 56.6 extends parallel to the longitudinal axis 113.6 extending through corresponding jaws 110.6 and 112.6 of the clamp assembly in this example. As seen in FIG. 12, the clamp assemblies 54.6 and 56.6 have non-rotated positions in which the longitudinal axes 180 of the bars 174 are offset from and extend parallel to the longitudinal axis 31.6 of the elongate member assembly 26.6.

The outer side portion 90.6 of each clamp assembly 56.6 is coupled to the second end 178 of its bar 174 in this example. Outer jaw 112.6 is thus coupled to the second end of the bar. The inner side portion 88.6 of each clamp assembly 56.6 is selectively moveable along and relative thereto the bar 174 between the first end 176 and the second end 178 of the bar. Inner jaw 110.6 is thus positioned between the first end and second end of the bar.

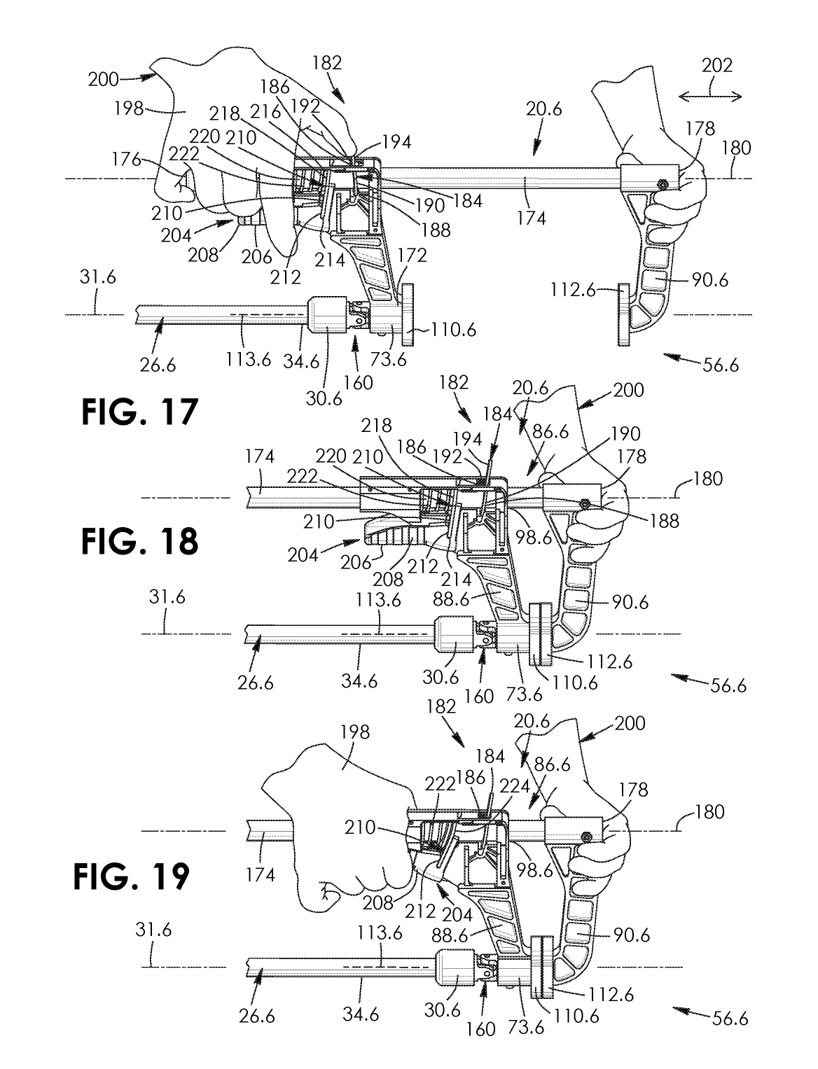

As seen in FIG. 17, each clamp assembly 56.6 includes a locking mechanism 182 biased to inhibit movement of the outer side portion 90.6 thereof relative to the inner side portion 88.6 thereof. The locking mechanism includes a locking member, in this example a locking plate 184, as well as a resilient member, in this example a coil spring 186. The locking plate has a first portion 188 with an aperture 190 extending therethrough to receive the bar 174 in this example. The first portion of the locking plate 184 extends within a recess 192 of the inner side portion 88.6 of the clamping assembly 56.6. The locking plate has a second portion 194 resiliently coupled to the inner side portion of the clamp assembly. As seen in FIG. 18, the second portion of the locking plate 184 is spring-biased towards a tilted position relative to the bar 174 via coil spring 186 in this example. The coil spring is disposed within recess 192.

Referring back to FIG. 17, portions 196 of the locking plate 184 adjacent to the aperture 190 thereof abut the bar 174 and inhibit movement of the outer jaw 112.6 when the locking plate is in its tilted position. The locking plate is thus spring biased to inhibit movement of the outer jaw of the clamp assembly 56.6 relative to the inner jaw 110.6 of the clamp assembly. Actuation of the locking plate 184 towards a non-tilted position via the hand 198 of user 200, seen in FIG. 17, enables the outer side portion 90.6 of the clamp assembly 56.6 to be readily moveable relative to the inner side portion 88.6 of the clamp assembly. This movement is shown by arrow of numeral 202.

As seen in FIG. 18, each clamp assembly includes a trigger mechanism 204. Each trigger mechanism includes an actuation lever 206 pivotable relative to its said bar 174. The lever includes a gripping handle 208 that pivotally couples to inner side portion 88.6 of the clamp assembly 56.6 and which generally extends parallel to the bar when in a non-actuated state.

Referring to FIG. 17, the actuation lever 206 includes a trigger member, in this example a trigger plate 210 operatively connected to the lever 206. The trigger plate extends perpendicular to the gripping handle 208 in this example. The trigger plate 210 has a first portion 212 shaped to fit within a corresponding groove 214 of the gripping handle 208. The trigger plate has a second portion 216 with an aperture 218 extending therethrough to receive the bar 174 in this example. The second portion of the trigger plate 210 extends within an interior 220 of the inner side portion 88.6 of the clamping assembly 56.6. The second portion 216 of the trigger plate is resiliently coupled to the inner side portion of the clamp assembly via a coil spring 222 in this example. The spring is disposed within the interior 220 of the inner side portion of the clamping assembly and extends about bar 174. As seen in FIG. 17, the locking plate 184 and trigger plate 210 extend in opposite directions relative to each other in this example.

The trigger plate is spring-biased towards a non-tilted position seen in FIG. 17 that enables movement of the second jaw 112.6 relative to the first jaw 110.6. Actuation of the gripping handle 208, as seen in FIG. 19 by hands 198 of user 200, causes the trigger plate 210 to move towards a tilted position seen in FIG. 19. This causes at least a portion 224 of the trigger plate to abut the bar 174, and which in turn both causes the locking plate 184 to move towards a non-tilted position seen in FIG. 17 and causes jaw 112.6 to move incrementally towards jaw 110.6. Actuation of the lever 206 thus incrementally moves the jaws towards each other. The trigger mechanism 204 thus selectively moves the outer jaw 112.6 towards the inner jaw 110.6. The inner jaws 110.6 of the clamp assemblies 56.6 are thus fixed with the outer jaws 112.6 of the clamp assemblies being moveable relative to the inner jaws thereof in this example. Actuation of the trigger mechanism thus disengages the locking mechanism 182 and enables incremental movement of the outer side portion 90.6 of the clamp assembly 56.6 towards the inner side portion 88.6 of the clamp assembly.

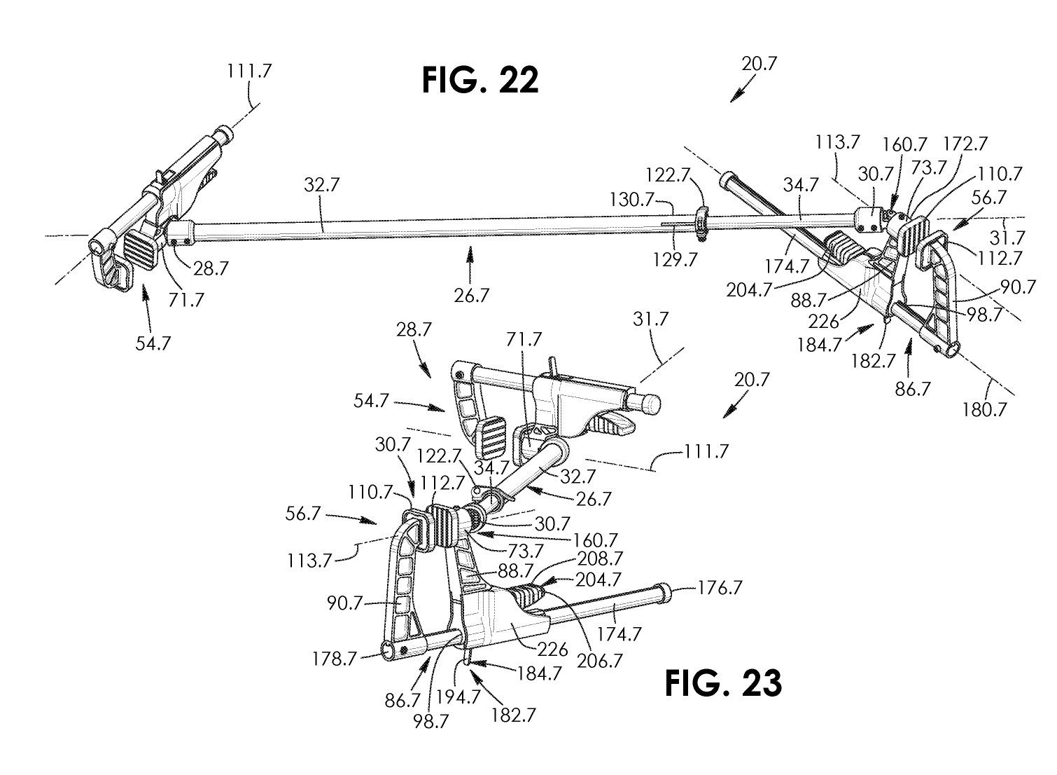

FIGS. 22 to 23 show a door/casement holder 20.7 according to an eighth embodiment. Like parts have like numbers and function as the embodiment shown in FIGS. 12 to 21 with decimal extension “.7” replacing decimal extension “.6” and being added to part numbers not previously having decimal extensions. Holder 20.7 is substantially the same as holder 20.6 shown in FIGS. 12 to 21 with the exception that each of the clamp assemblies 54.7 and 56.7 includes an outer housing or shell 226 which encloses at least in part the trigger mechanisms 204.7 and locking mechanisms 182.7 thereof.

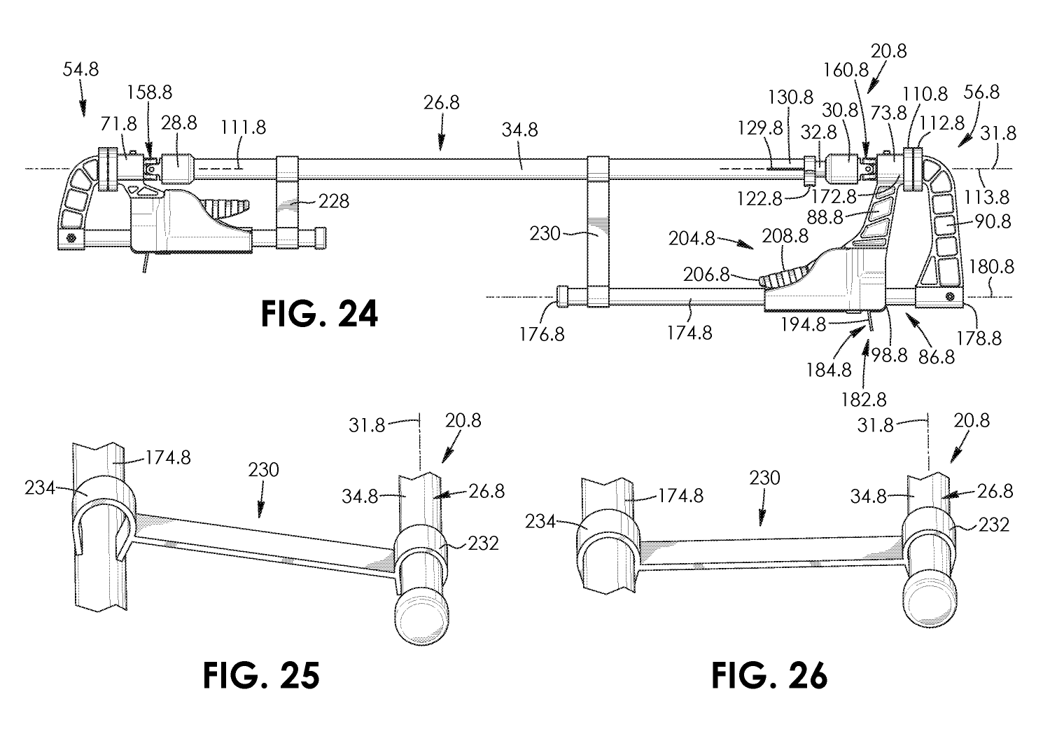

FIGS. 24 to 26 show a door/casement holder 20.8 according to a ninth embodiment. Like parts have like numbers and function as the embodiment shown in FIGS. 12 to 21 with decimal extension “.8” replacing decimal extension “.6” and being added to part numbers not previously having decimal extensions. Holder 20.8 is substantially the same as holder 20.6 shown in FIGS. 12 to 21 with the exception that the holder 20.8 further includes a pair of storage brackets 228 and 230.

Referring to FIG. 25, each bracket is resilient in part, includes a base portion 231 that is a rectangular prism in shape in this example, and has a pair of spaced-apart ends 232 and 234 that are c-shaped in cross-section in this example. End 232 is shaped to selectively couple to and snap fit with tube 34.8 of the elongate member assembly 26.8. End 234 is shaped to selectively couple to its respective bar 174.8 of the clamp assemblies 56.8 when the holder 20.8 is not in use and the axes of the bars 174.8 are positioned parallel to axis 31.8 of the elongate member assembly 26.8.

Many advantages result from the structure of the present invention. For example, the invention is compact and portable on the one hand, while also being configured to accommodate existing doors and windows of a wide variety of shapes and sizes.

The clamp assemblies as herein described are shaped to support large lateral forces resulting from closers and wind loading in addition to the in-line clamping forces. This lateral loading may be much larger than the direct clamping load. For example, the clamp assemblies 56.6 to 56.8 provide universal joints adjacent to the clamp surfaces thereof, with bars 174.6 to 174.8 separate from the load bearing elongate member assembly 26.6 to 26.8. The holder so shaped and described may result in the force holding the door or casement open being closer to the clamping surface, thereby inhibiting larger bending movements in the bodies of the clamp assemblies. This may result in a more robust and compact holder that may be manufactured in an economic manner.

The holder as herein described may greatly benefit the Service/Food/Retail Industry, Moving/Transportation Industry, Trades/Constructions/Renovations Industry, Parcel & Package Delivery Industry and residential users. The need to keep exterior/interior building doors open for a short or long period of time will always be here and the need for an effective doorstop will only keep growing. Often times, exterior doors and common place firewall doors are too heavy and difficult to keep open with any of the traditional door stoppers in the market. Additionally, the gap between the bottom of the door and the ground/floor is too large and/or too slippery for door wedges of any kind to work. None of these options are efficient and/or safe. For many years, people continue to use ineffective doorstops that can at best only keep doors slightly ajar. Some resort to using cinder blocks, heavy large objects/furniture, door hinge wedges that damage doors or cardboard to jam the hinges of a door, but in the end everyone is left frustrated with the process. This why the casement/door holder was created: as a solution to a problem many have been facing for decades. The two end jaw clamps are designed to safely and securely grip the door and the door frame. The telescopic rod-in-rod that connects the two jaw clamps, can be extended to achieve a larger door opening in order to clear a safe pathway with nothing to trip or stub toes on. The holder may eliminate the frustration with doors closing shut and the time wasted searching for something to jam the hinge.

No matter if there is a truckload of boxes to be delivered to clients or if it is the day of a move, the holder as herein described is a reliable doorstop needed to efficiently get the job done: a quick in and out with the added bonus that it will not damage doors and/or door frames. While the available doorstops in the market may stop doors from fully closing, their biggest shortcoming is not being able to keep doors in a fully opened position, rendering the tool useless to the user with a goal to create an open and clear pathway. The automatic door closing mechanism that exist on most commercial building doors may add too much force on door stoppers, causing them to buckle and/or break under prolong force stress in keeping doors open. These doorstops are quite inefficient and unsafe, not to mention the damage they cause to door frames, doors and the user. The holder has herein described is built to withstand the force placed on it by door closers. On the plus side, the holder can be used for windows that do not have a functioning window stay to effectively keep it open due to wind or window style. cl Additional Description

Examples of door/casement holders have been described. The following clauses are offered as further description.
(1) A holder for at least one of a door and a casement, the at least one of the door and the casement being hingedly connected to a frame, and the holder comprising: an elongate member assembly moveable from a retracted position to an extended position, the elongate member assembly having a pair of spaced-apart ends; and a pair of clamp assemblies pivotally connected to respective ones of said ends of the elongate member assembly, the clamp assemblies being configured to selectively couple with the frame and the at least one of the door and the casement.
(2) The holder of clause 1 wherein the elongate member assembly comprises a first tube and a second tube telescopically coupled to the first tube.
(3) The holder of clause 2 wherein the elongate member assembly includes a locking mechanism, actuation of which inhibits movement of the first tube relative to the second tube.
(4) The holder of clause 1 wherein each of the clamp assemblies couples to the elongate member assembly via at least one ball joint.
(5) The holder of clause 1 wherein each of the clamp assemblies couples to the elongate member assembly via a pair of ball joints.
(6) The holder of clause 1 wherein each of the clamp assemblies has an open position and is spring-biased towards a closed position.
(7) The holder of clause 1 wherein each of the clamp assemblies is U-shaped and includes a pair of threaded screws, actuation of which moves the clamp assembly from an unclamped position to a clamped position.
(8) The holder of clause 1 wherein each of the clamp assemblies includes a length-adjustable base assembly and a pair of side portions coupled to and extending outwards from spaced-apart ends of the base assembly.
(9) The holder of clause 8 wherein each of the clamp assemblies includes a pair of thumb screws, each extending through a respective one of the side portions of the clamp assemblies, whereby each said clamp assembly is clamped in place via actuation of said thumb screws.
(10) The holder of clause 8 wherein each of the clamp assemblies includes a pair of jaws positioned between the side portions thereof, the jaws being spring-biased towards each other.
(11) The holder of clause 8 wherein each of the clamp assemblies includes a pair of rods slidably extendable through respective ones of the side portions of the clamp assemblies, each said rod having an outer hand-grippable end and an inner end, wherein each of the clamp assemblies includes a pair of jaws coupled to respective ones of the inner ends of the rods, the jaws being positioned between the side portions of the clamp assemblies, and wherein each of the clamp assemblies includes a pair of resilient members, each said resilient member extending about a respective one of the rods, having an outer end abutting a respective one of the side portions, and having an inner end abutting a respective one of the jaws, the jaws being spring-biased towards each other.
(12) The holder of clause 1 wherein each said clamp assembly is U-shaped and includes a threaded screw actuation of which moves the clamp assembly from an unclamped position to a clamped position.
(13) The holder of clause 1 wherein each said clamp assembly is U-shaped and includes a pair of side portions, a first of the side portions being spring-biased towards a second of the side portions.
(14) The holder of clause 13 wherein each said first of the side portions of the clamp assemblies includes a handle for selectively spacing-apart the first of the side portions from the second of the side portions of the clamp assemblies.
(15) The holder of clause 1 further including a first one of a first set of a ball and a socket coupled to a first said end of the elongate member assembly, a second one of the first set of the ball and the socket pivotally connecting to the first one of the first set of the ball and the socket, a first one of a second set of a ball and a socket coupled to the second one of the first set of the ball and the socket, a second one of the second set of the ball and the socket pivotally connecting to the first one of the second set of the ball and the socket, the second one of the second set of the ball and the socket coupling to a first said clamp member, a first one of a third set of a ball and a socket coupled to a second said end of the elongate member assembly, a second one of the third set of the ball and the socket pivotally connecting to the first one of the third set of the ball and the socket, a first one of a fourth set of a ball and a socket coupled to the second one of the third set of the ball and the socket, and a second one of the fourth set of the ball and the socket pivotally connecting to the first one of the fourth set of the ball and the socket, the second one of the fourth set of the ball and the socket coupling to a second said clamp member.
(16) In combination, a door and the holder of any preceding clause.
(17) In combination, a casement and the holder of any preceding clause.

It will be appreciated that many variations are possible within the scope of the invention described herein. It will also be understood by someone skilled in the art that many of the details provided above are by way of example only and are not intended to limit the scope of the invention which is to be determined with reference to the following claims.

What is claimed is:

1. A door/casement holder comprising:
a length-adjustable elongate member assembly having a pair of spaced-apart ends; and
a pair of clamp assemblies pivotally coupled to said ends of the elongate member assembly, each said clamp assembly including an inner jaw positioned adjacent to a respective said end of the elongate member assembly.

2. The holder as claimed in claim 1 wherein the clamp assemblies pivotally couple to said ends of the elongate member assembly via universal joints and wherein each said inner jaw is adjacent to a respective said universal joint.

3. The holder as claimed in claim 1, wherein the elongate member assembly has a longitudinal axis extending between the ends thereof, wherein each said clamp assembly includes an outer jaw and has a longitudinal axis extending between the jaws thereof, and wherein the clamp assemblies have non-rotated positions in which the longitudinal axes thereof align with the longitudinal axis of the elongate member assembly.

4. The holder as claimed in claim 1 further including a pair of spaced-apart outer elongate members, the length-adjustable elongate member pivotably coupling to and extending between said outer elongate members, and the inner jaws coupling to distal ends of the outer elongate members.

5. The holder as claimed in claim 1 wherein each of the clamp assemblies includes an outer jaw and a trigger mechanism for selectively moving the outer jaw towards the inner jaw thereof.

6. The holder as claimed in claim 1 wherein each said clamp assembly includes an outer jaw that is moveable relative to the inner jaw thereof.

7. The holder as claimed in claim 1 wherein each of the clamp assemblies includes an outer side portion, an outer jaw coupled to said outer side portion, an inner side portion to which the inner jaw is coupled, and a bar to which the outer side portion is coupled and relative to which the inner side portion is selectively moveable along, the bar being spaced-apart from the elongate member assembly.

8. The holder as claimed in claim 7 wherein the elongate member assembly has a longitudinal axis, wherein the bar has a longitudinal axis, and wherein the clamp assemblies have non-rotated positions in which the longitudinal axes of the bars are offset from and extend parallel to the longitudinal axis of the elongate member assembly.

9. The holder as claimed in claim 7 wherein each said clamp assembly includes a locking member which is biased to inhibit movement of the outer jaw thereof relative to the inner jaw thereof and actuation thereof enables the outer side portion thereof to be readily moveable relative to the inner side portion thereof.

10. The holder as claimed in claim 7 wherein each said clamp assembly includes a locking member, the locking member having a first portion with an aperture extending therethrough to receive the bar, the locking member having a second portion resiliently coupled to the inner side portion, wherein the second portion of the locking member is biased towards a tilted position relative to the bar in which portions of the locking member adjacent to said aperture abut the bar and inhibit movement of the outer jaw, and wherein actuation of the locking member towards a non-tilted position enables the outer side portion to be readily moveable relative to the inner side portion.

11. The holder as claimed in claim 7 wherein each said clamp assembly includes a locking mechanism being biased to inhibit movement of the outer side portion relative to the inner side portion and wherein each said clamp assembly includes a trigger mechanism, actuation of which disengages the locking mechanism and enables incremental movement of the outer side portion towards the inner side portion.

12. The holder as claimed in claim 10 wherein each said clamp assembly includes a trigger mechanism, actuation of which moves the locking member from said tilted position to said non-tilted position and enables incremental movement of the outer side portion towards the inner side portion.

13. The holder as claimed in claim 11 wherein each said trigger mechanism includes an actuation lever pivotable relative to its said bar and which, when unactuated, extends generally parallel to its corresponding said bar.

14. The holder as claimed in claim 7 further including a pair of storage brackets, each bracket having a first end that selectively couples to the elongate member assembly and a second end that selectively couples to a respective one of the bars of the clamp assemblies when the holder is not in use.

15. A clamp assembly comprising:
a bar having a first end and a second end;
a first jaw coupled to the first end of the bar;
a second jaw positioned between the first end and the second end of the bar; and
a lever, actuation of which incrementally moves the second jaw towards the first jaw, the lever generally extending parallel to the bar.

16. The clamp assembly as claimed in claim 15 including a locking member biased towards a tilted position in which portions thereof abut the bar and inhibit movement of the second jaw relative to the first jaw, and a trigger member operatively connected to the lever, the trigger member being biased towards a non-tilted position that enables movement of the second jaw relative to the first jaw.

17. The clamp assembly as claimed in claim 16 wherein the locking member and the trigger member extend in opposite directions relative to each other.

18. The clamp assembly as claimed in claim 16 wherein actuation of the lever causes the trigger member to move towards a tilted position, which causes at least a portion of the trigger member to abut the bar, and which in turn both causes the locking member to move towards a non-tilted position and causes the first jaw to move incrementally towards the second jaw.

19. A holder for at least one of a door and a casement, the at least one of the door and the casement being hingedly connected to a frame, and the holder comprising:
an elongate member assembly moveable from a retracted position to an extended position, the elongate member assembly having a pair of spaced-apart ends; and
a pair of clamp assemblies pivotally connected to respective ones of said ends of the elongate member assembly, the clamp assemblies being configured to selectively couple with the frame and the at least one of the door and the casement.

20. In combination, the holder as claimed in claim 19 and one of a door and a casement.
